(19) United States
(12) Patent Application Publication
(10) Pub. No.: US 2005/0225581 A1
(43) Pub. Date: Oct. 13, 2005

(54) Print method for an inkjet printer and an inkjet printer suitable for using such a method

(75) Inventor: Hubertus M.J.M. Boesten, ES Melick (NL)

Correspondence Address: BIRCH STEWART KOLASCH & BIRCH, PO BOX 747, FALLS CHURCH, VA, 22040-0747, US

(73) Assignee: OCE-TECHNOLOGIES B.V., Ma Venlo (NL)

(21) Appl. No.: 11/099,576

(22) Filed: Apr. 6, 2005

(30) Foreign Application Priority Data
Apr. 7, 2004 (NL) 1025894

(51) Int. Cl. B41J 29/38

(52) U.S. Cl. 347/10

(57) ABSTRACT

A method for printing with an inkjet printer containing an ink-filled chamber provided with a nozzle, which chamber is operatively connected to a piezoelectric actuator, which includes the steps of electrically energizing the actuator so that it is deformed, with the formation of a pressure wave in the chamber as a result of this deformation, by means of which pressure wave a drop of ink is ejected from the nozzle and the actuator is deformed, as a result of which deformation said actuator generates an electric signal, analysis of said signal, wherein prior to the analysis the signal is adapted by removing from said signal a non-random contribution to said signal which is not the result of the said energization of the actuator. The invention also relates to an inkjet printer adapted to the performance of said method.

### BACKGROUND OF THE INVENTION

This non-provisional application claims priority under 35 U.S.C. § 119(a) on Patent Application No. 1025894 filed in The Netherlands on Apr. 7, 2004, which is herein incorporated by reference.

The present invention relates to a print method for an inkjet printer containing an ink-filled chamber provided with a nozzle, and operatively connected to a piezoelectric actuator. The method includes the steps of electrically energising the actuator so that it is deformed, and forming of a pressure wave in the chamber as a result of this deformation, to eject a drop of ink from the nozzle. A result of the deformation the actuator generates an electrical signal, which is analysis of said signal. The present invention also relates to a printer suitable for use in the present method.

A method of this kind is known from European application EP 1,013,453. An inkjet printer of the piezo type has a printhead containing an ink chamber of ink (also termed “ink duct” or, in short, “duct”), operatively connected to a piezoelectric actuator. In one embodiment, the ink chamber has a flexible wall which is deformable by energization of the actuator connected to the wall. Deformation of the wall results in a pressure wave in the chamber and given sufficient strength the pressure wave will result in the ejection of an ink drop from the nozzle of the chamber. However, the pressure wave, in turn, results in a deformation of the wall, and this may be transmitted to the piezoelectric actuator. Under the influence of its deformation the actuator will generate an electrical signal.

From the European application it is known that the analysis of the electrical signal enables information to be obtained concerning the state of the ink chamber corresponding to the actuator. Thus it is possible to derive from this signal whether there is an air bubble or other irregularity in the chamber, whether the nozzle is clean, whether there are any mechanical defects in the ink chamber, and the like. In principle, any irregularity influencing the pressure wave itself can be traced by analyzing the signal.

A disadvantage of the known method is that the signal generated by the piezoelectric actuator as a reaction to its deformation by the pressure wave in the duct is often very complex, apart from the possible presence of random interference (noise). It has been found that the pressure wave in the duct is not a simple sine wave or other simple wave form. This would necessarily result in a comparably simple signal. The pressure wave is evidently not generated just by the deformation of the actuator directly prior to drop ejection but there are also numerous other incidents which generate this pressure wave. The result of this complex pressure wave is that the signal generated by the actuator as a result of the pressure wave is also very complex. The analysis of such a complex signal requires a complex measuring circuit and/or relatively long processing times. This is a disadvantage, particularly for inkjet printers with many ink chambers, if each chamber of the printer has to be checked for irregularities after each energization. First of all, it will be an expensive matter to integrate in the inkjet printer a measuring circuit of this kind for each chamber, and in addition it will often be difficult to complete an analysis within the time available until a following ink drop has to be ejected from the chamber (typically in 10⁻⁴ seconds). It should be clear that particularly for applications in which high print quality is required, for example in the printing of color photographs and the making of advertising posters, it is desirable to check each ink chamber after each energization.

### SUMMARY OF THE INVENTION

The object of the invention is to produce a method to obviate the above-described disadvantages. To this end, a method has been invented wherein prior to the analysis the signal is adapted by removing from said signal a non-random contribution to said signal which originates from a different incident from the said energization of the actuator. This invention utilises the realisation that events other than the said energization of the actuator are at least partly pre-known events. For example, the chamber may have residual waves from previous energizations of the piezoelectric actuator. Mechanical deformations of the inkjet head having a different origin from the energization of the piezoelectric actuator of the ink chamber, such as a periodic deformation generated somewhere in the printhead for the printing process, may also influence the pressure wave for example. Other events which must take place for the printing process but which do not cause direct deformation of the head and hence the ink-filled chamber, can also result in an appreciable contribution to the pressure wave in the chamber. Consequently these events also cause a noticeable contribution in the electric signal generated by the piezoelectric actuator when it is deformed by said pressure wave. This causes pollution of the actual signal for analysis, namely the signal that would arise if the pressure wave in the chamber were caused solely by the energization of the piezo actuator directed towards ejection of an ink drop. The invention now utilises the fact that a contribution to the pressure wave is often so determined as a result of one or more of these events that the contribution thereof in the electric signal can also be pre-determined. It would be possible to determine this contribution, for example, prior to, after production of the printer, or at regular intervals during a service period. Once determined, this means that a contribution of this kind can be removed from the signal, for example using a suitable filter. This results in a much “cleaner” signal, from which irregularities in the ink chamber can be traced much more easily.

In one embodiment, a contribution in the signal resulting from one or more earlier energizations of the same actuator is removed. It has been found that a pressure wave generated by energization of the piezo actuator requires a relatively long time to completely decay. In a typical piezo inkjet head, the actuators are energised at a frequency of 10⁴ Hz maximum. This means that the time between two actuations, in the case that two drops of ink have to be jetted from the same chamber with the minimum intermediate time, is only a period of 1*10⁻⁴ second. In this short time, a pressure wave will often not be completely damped. Consequently, on a new actuation, if there has been an actuation also directly prior to this, there will be an appreciable residual pressure wave from this prior pressure wave in the chamber. This residual pressure wave also provides a contribution to the deformation of the piezo actuator, and accordingly a contribution to the electric signal generated by this piezo actuator in response to the deformation. Depending on the acoustics in the chamber, conditions may be such that there is still an appreciable residual pressure wave present from an actuation that took place two or more of these periods of 1*10⁻⁴ seconds prior to the new energization. Since a residual pressure wave of this kind is distinctly defined and can be predetermined, the contribution thereof in the signal for analysis can also be determined. Removal of this contribution enables the signal for analysis to be simpler. It should be noted that the time between two jet pulses can deviate slightly from a number of times the above period, for example because the movement of the printheads is not completely uniform. Of course, the present invention can take such a deviation into account.

In another embodiment, wherein the printer comprises one or more additional chambers for ejection of ink drops, a contribution to the signal for analysis as a result of an energization of one or more of said additional chambers is removed from said signal. It has been found that energization of a piezo actuator of a near-by chamber can also result in a pressure wave in the chamber under consideration. Energization of a near-by actuator of this kind often also results in a deformation of the surroundings of said actuator. If the chamber under consideration is in the zone where this deformation is appreciable, this deformation can therefore result in a pressure wave in this chamber. Since this deformation can be distinctly predetermined, the final contribution thereof in the signal for analysis from the chamber under consideration can also be predetermined. By use of the invention this contribution is removed from the signal.

The invention also relates to a printer comprising an ink-fillable chamber provided with a nozzle and operatively connected to a piezoelectric actuator which can generate a pressure wave in the chamber by energization and which is connected to a measuring circuit in order to measure an electric signal generated by said actuator as a result of a deformation thereof by the pressure wave, wherein the measuring circuit is provided with a filter in order to remove from the signal a non-random contribution to said signal which does not originate in the said energization of the actuator.

### BRIEF DESCRIPTION OF THE DRAWINGS

The present invention will now be explained with reference to the following drawings wherein.

FIG. 1 is a diagram of an inkjet printer;

FIG. 2 diagrammatically illustrates a component of the inkjet printhead;

FIG. 3 is a diagrammatic illustration of an electric circuit suitable for use of the method according to the present invention; and

FIGS. 4A, 4B and 4C diagrammatically indicate a number of signals arising as a result of the deformation of a piezoelectric actuator.

### DETAILED DESCRIPTION OF THE INVENTION

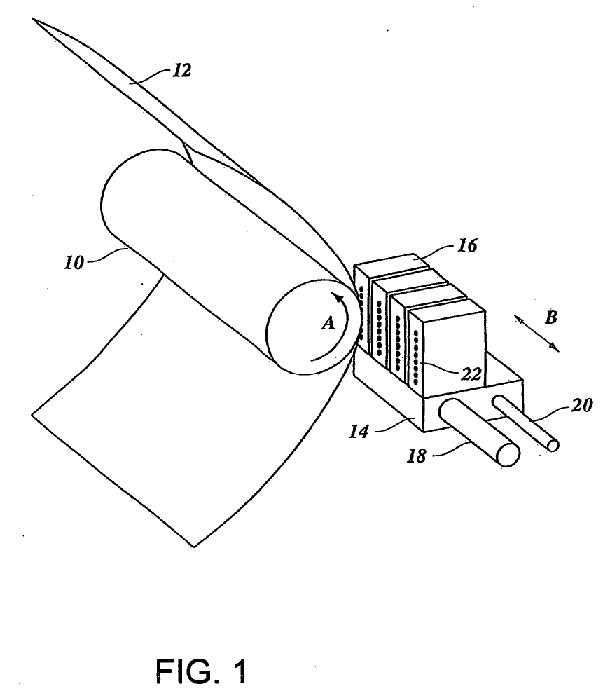

FIG. 1 diagrammatically illustrates an inkjet printer. In this embodiment, the printer comprises a roller 10 to support a receiving medium 12 and guide it along the four printheads 16. The roller 10 is rotatable about its axis as indicated by arrow A. A carriage 14 carries the four printheads 16, one for each of the colors: cyan, magenta, yellow and black, and can be moved in reciprocation in a direction indicated by the double arrow B parallel to the roller 10. In this way the printheads 16 can scan the receiving medium 12. The carriage 14 is guided on rods 18 and 20 and is driven by means suitable for the purpose (not shown).

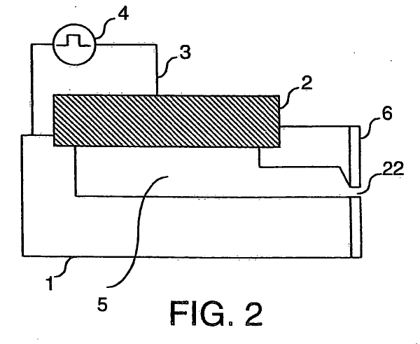

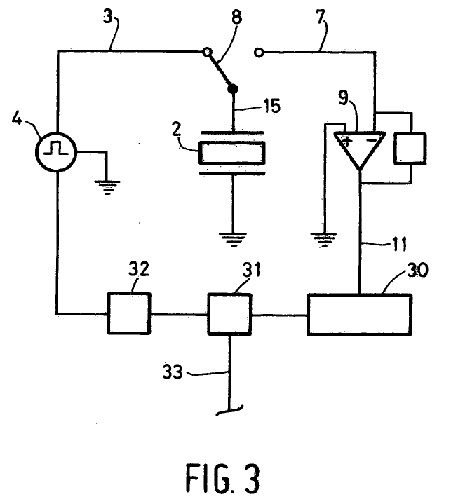

In the embodiment shown in the drawing, each printhead 16 comprises eight ink chambers, each with its own exit opening 22, which form an imaginary line perpendicular to the axis of the roller 10. In a practical embodiment of a printing device, the number of ink chambers per printhead 16 is many times greater. Each ink chamber is provided with a piezoelectric actuator (not shown) and associated actuation and measuring circuit (not shown) as described in connection with FIGS. 2 and 3. Each of the printheads also includes a control unit for adapting the actuation pulses. In this way the ink chamber, actuator, actuation circuit, measuring circuit and control unit form a system serving to eject ink drops in the direction of the roller 10. Incidentally it is not essential for the control unit and/or for example, all the elements of the actuation and measuring circuit to be incorporated physically in the actual printheads 16. It is also possible for these elements to be disposed, for example, in the carriage 14 or even in a more remote component of the printer, there being connections to components in the printheads 16 themselves. In this way, these elements nevertheless form a functional component of the printheads without actually being physically incorporated in the printheads. If the actuators are energised image-wise, an image which is built up from individual ink drops forms on the receiving medium 12.

In FIG. 2, an ink chamber 5 is provided with an electromechanical actuator 2, in this example a piezoelectric actuator. Ink chamber 5 is formed by a groove in baseplate 1 and is defined at the top mainly by the piezoelectric actuator 2. At the end, ink chamber 5 merges into an exit opening 22 formed by a nozzle plate 6 in which a recess is made at the duct location. When a pulse is applied across actuator 2 by a pulse generator 4 via the actuation circuit 3, the actuator is deflected in the direction of the duct. As a result, the pressure in the duct is suddenly increased so that an ink drop is ejected from the exit opening 22. Upon the completion of the drop ejection there is still a pressure wave present in the duct and this decays in the course of time. This wave in turn results in a deformation of the actuator 2 which then generates an electric signal. This signal is dependent on all the parameters which influence the formation of the pressure wave and the damping thereof. In this way, information concerning these parameters can be obtained by measuring said signal. This information can in turn be used to control the print process.

FIG. 3 is a block schematic of the piezoelectric actuator 2, the actuation circuit (elements 3, 8, 15, 2 and 4), the measuring circuit (elements 2, 15, 8, 7, 9, 11, 30 and 31) and control unit 31 in a preferred embodiment. The actuation circuit, provided with pulse generator 4, and the measuring circuit, provided with amplifier 9, are connected to actuator 2 via a common line 15. The circuits are broken and closed by tumbler switch 8. After a pulse has been applied across actuator 2 by the pulse generator 4, said element 2 is, in turn, deformed by the resulting pressure wave in the ink chamber. This deformation is converted to an electric signal by actuator 2. On completion of the actual actuation of the actuator, switch 8 is switched over so that the actuation circuit is broken and the measuring circuit closed. The electric signal generated by the actuator is collected by amplifier 9 via line 7. In this embodiment, the accompanying voltage is fed via line 11 to filter 30 which, in addition to any noise present, removes a non-random contribution in this voltage if it is not the direct result of the said pulse applied across the actuator 2. A contribution of this kind can be stored in a memory (not shown) and simply eliminated from the actual signal. Active adaptation of the non-random contribution for correction also forms part of the scope of the present invention. For this purpose, the unit 30 can receive information concerning the printing process via a processor (not shown).

The corrected signal is fed to analysis unit 31. Here the actual analysis of the signal takes place as known from the prior art referred to earlier in this specification. If necessary, a control signal is delivered to pulse generator 4 via unit 32. If, for example, the analysis shows that there is a disturbing air bubble or obstruction in the chamber, so that the ejection of the ink drop is obstructed, then the generation of pulses is interrupted via unit 32. Unit 31 is connected to a central processor of the printer (not shown) via line 33. In this way, information can be exchanged with the rest of the printer and/or the outside world.

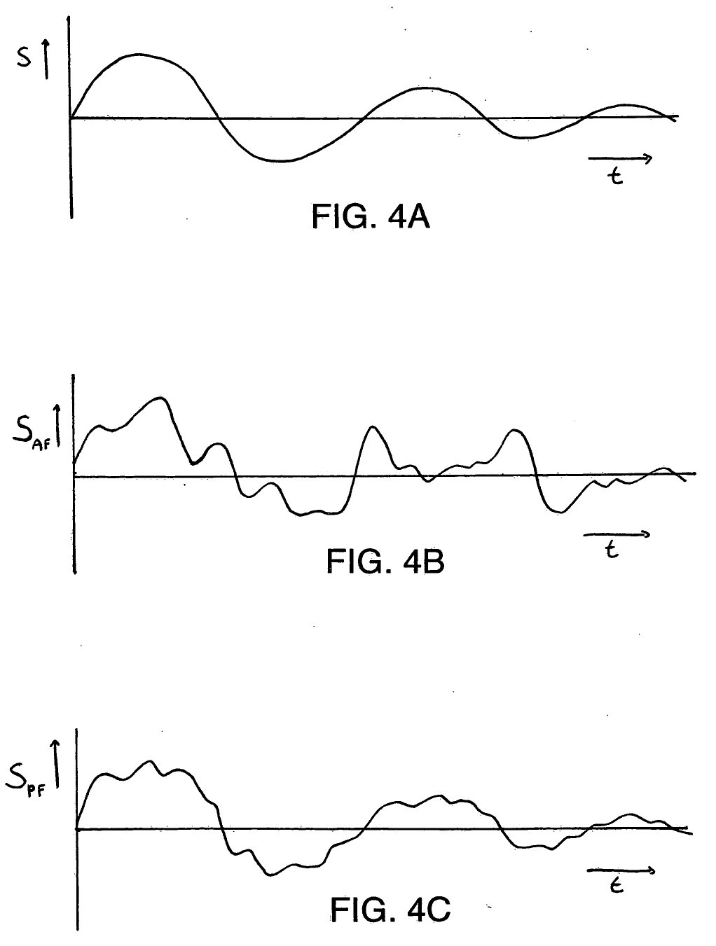

FIG. 4, subdivided into FIGS. 4A, 4B and 4C, indicates a number of electric signals which can arise as a result of the deformation of a piezoelectric actuator.

FIG. 4A is an example of a signal as generated by the actuator when deformed by the presence of a pressure wave in the ink chamber. This damped sine wave is a signal that could be generated by a piezoelectric actuator operatively connected to an ink chamber in which there are no disturbances (such as air bubbles, deposits, mechanical defects and the like) and where there are no other influences on the pressure wave than the originally initiated pressure wave resulting from energizing of the piezoelectric actuator. What then forms is a simple pressure wave which decays slowly, which pressure wave in turn results in generation of a sinusoidal electric signal by the piezoelectric actuator deformed by said pressure wave.

FIG. 4B is an example of an electric signal of the kind that could be generated by the piezoelectric actuator in a practical situation, i.e. during the actual use of the printer to make an image. This signal is relatively complex because the pressure wave underlying the deformation of the actuator was not only the result of the energizing of the piezo actuator itself but, for example, also had a contribution from residual pressure waves present which had not been completely damped when the piezoelectric actuator was energised, and a contribution originating from the energizing of the piezo actuators of near-by ink chambers (cross-talk). This is the signal as fed to unit 32 via line 11 (see FIG. 3). Analysis of this signal as such would require complex components and computing methods.

FIG. 4C shows the same signal as FIG. 4B but corrected for the contributions of residual pressure waves and cross-talk. For this purpose unit 30 (see FIG. 3) filters these contributions from the signal. The adapted signal is fed to unit 31. In this case, a high-frequency disturbance is apparent on the base signal. In this case this is indicative of a mechanical fault in the concerned ink chamber.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A printing method for an inkjet printer containing an ink-filled chamber provided with a nozzle, said chamber being operatively connected to a piezoelectric actuator, which comprises:
electrically energising the actuator so that it is deformed,
forming a pressure wave in the chamber as a result of the actuator deformation, by means of which pressure wave a drop of ink is ejected from the nozzle, and the actuator is deformed, as a result of which deformation said actuator generates an electric signal, and
analyzing said signal,
wherein prior to the analysis, the signal is adapted by removing from said signal a non-random contribution to said signal which is not the result of the energizing of the actuator.

2. The method according to claim 1, wherein a contribution to the signal as a result of one or more previous energizations of the same actuator is removed.

3. The method according to claim 1, wherein the printer comprises one or more additional chambers for the ejection of ink drops, wherein a contribution to the signal caused by the energizing of one or more of said additional chambers is removed from said signal.

4. A printer comprising an ink-fillable chamber provided with a nozzle and operatively connected to a piezoelectric actuator which can generate a pressure wave in the chamber by energization and which is connected to a measuring circuit for measuring an electric signal generated by said actuator as a result of the deformation thereof by the pressure wave, wherein the measuring circuit is provided with a filter in order to remove from the signal a non-random contribution to said signal which does not originate in the energization of the actuator.
